(19) United States
(12) Patent Application Publication
(10) Pub. No.: US 2007/0209464 A1
(43) Pub. Date: Sep. 13, 2007

(54) Damped yoke bearing for a power steering system

(76) Inventors: Eric Alfred Roline, Morristown, TN (US); Scott Little, Rogersville, TN (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/362,969

(22) Filed: Feb. 27, 2006

(51) Int. Cl. F16H 35/00

(52) U.S. Cl. 74/422; 74/388 PS

(57) ABSTRACT

A steering assembly for use in turning wheels of a vehicle includes a rack and a pinion. A yoke is continuously pressed against the rack by a yoke spring. A damper, preferably arranged in series with the spring, produces damped resistance to displacement of the yoke away from the rack. The damper produces a relative high magnitude of damped resistance to displacement of the yoke away from the rack and a lower magnitude of damped resistance to displacement of the yoke toward the rack.

### BACKGROUND OF THE INVENTION

The present invention relates generally to yoke in which a rack is biased toward engagement with a pinion of the power steering system for a motor vehicle. In particular, the invention pertains to a yoke damper for resisting movement of the rack away from engagement with the pinion.

A rack and pinion steering assembly includes a rack, which is disposed in meshing engagement with a pinion. A housing encloses the rack and pinion. A yoke presses the rack toward the pinion to maintain meshing engagement between gear teeth on the rack and gear teeth on the pinion. The steering assembly may be assisted by a fluid motor to reduce the level of effort required by the operator to change the position of the steered wheels.

It is conventional to rely on a compression spring to maintain a biasing force between the yoke and rack. In operation, however, the yoke bearing is susceptible to large loads induced by road surface imperfections tending to disengage the rack and the pinion. It is desirable to augment the spring force with the force of a damper that would resist such disengagement.

### SUMMARY OF THE INVENTION

A steering assembly for use in turning wheels of a vehicle includes a rack and a pinion. A yoke is continuously pressed against the rack by a yoke spring. A damper, arranged in series with the spring, produces damped resistance to displacement of the yoke away from the rack. The damper produces a relative high magnitude of damped resistance to displacement of the yoke away from the rack and a lower magnitude of damped resistance to displacement of the yoke toward the rack.

An alternate embodiment of the damped yoke bearing includes a housing, a first component formed with gear teeth for engaging gear teeth on a second component, a yoke located in the housing and containing viscoelastic material, a spring located in the housing for biasing the yoke into contact with the first component, and a surface secured to the housing, located for displacement into contact with the viscoelastic material in response to movement of the yoke relative to the surface. Preferably the viscoelastic material is a liquid injection molding elastomer.

A yoke bearing according to this invention produces a relative high magnitude of damped resistance to displacement of the yoke away from the rack and a lower magnitude of damped resistance to displacement of the yoke toward the rack. The force-displacement characteristic of the damped yoke is established by the physical properties of hydraulic fluid located in the damper and of viscoelastic material in the damper.

The damper material can be a range of materials from liquids to pastes to low durometer rubbers to high durometer urethanes, etc. The durometer selected for the damper material works in both compression and shear. The compression and shear functions can also be altered by the viscosity or durometer of the material. Typical values are from 10 cp to 90 Shore A. By controlling the contact surface areas, the load-deflection characteristic of the yoke bearing can be altered. The load-deflection profile represents the energy dissipation and absorption capability of the assembly.

The damper material (liquid/gel/paste/plastic) may be either installed during gear assembly or by having it delivered as an assembly ready for installation. A spring provides the primary yoke loading, which controls returnability, but damping is provided by the additional materials. By absorbing the compression displacement forces, the yoke bearing displacement is minimized, thereby reducing, if not eliminating yoke rattle noise, and improving ride and handling accuracy.

### DESCRIPTION OF THE DRAWINGS

The present invention will become more fully understood from the detailed description given below, the appended claims, and the accompanying drawings, in which:

FIG. 1 is a side view partially in cross section illustrating a rack and pinion steering assembly to which the present invention may be applied;

FIG. 2 is a cross sectional view taken at plane 2-2 of FIG. 1 illustrating the rack, pinion and a dampened yoke bearing;

FIGS. 3A and 3B are cross sectional views through a yoke housing showing a first embodiment of a dampened yoke bearing;

FIGS. 4A and 4B are cross sectional views through a yoke housing showing a second embodiment of the invention employing viscoelastic dampening;

FIGS. 5A, 5B and 5C are cross sectional views showing alternate check valves for use with the dampened yoke bearing of FIGS. 4A and 4B;

FIG. 6A-6D are cross sectional views through a yoke housing showing four embodiments of a dampened yoke bearing employing viscoelastic material wherein the load vs. deflection relation varies with surface area.

### DESCRIPTION OF THE PREFERRED EMBODIMENT

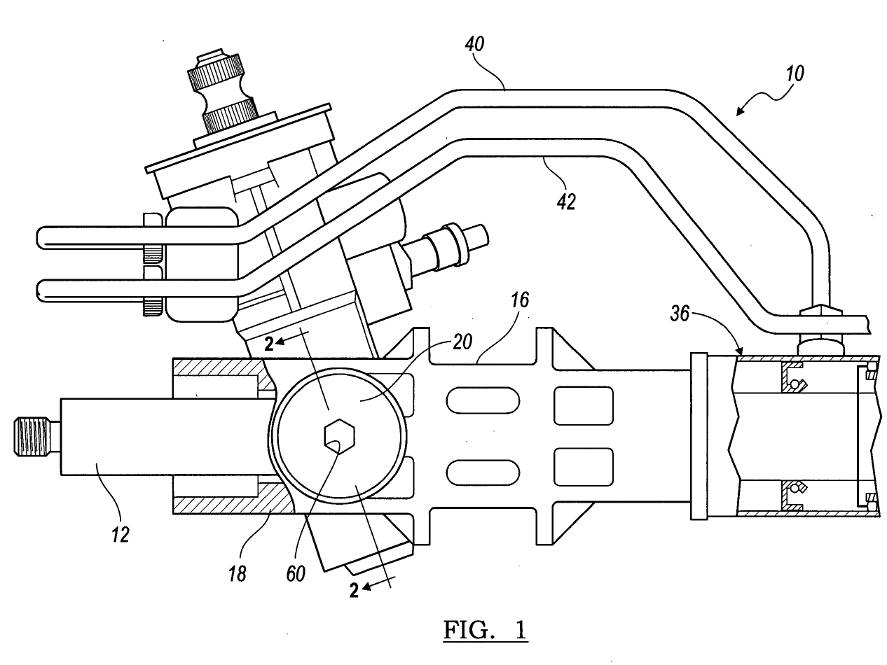

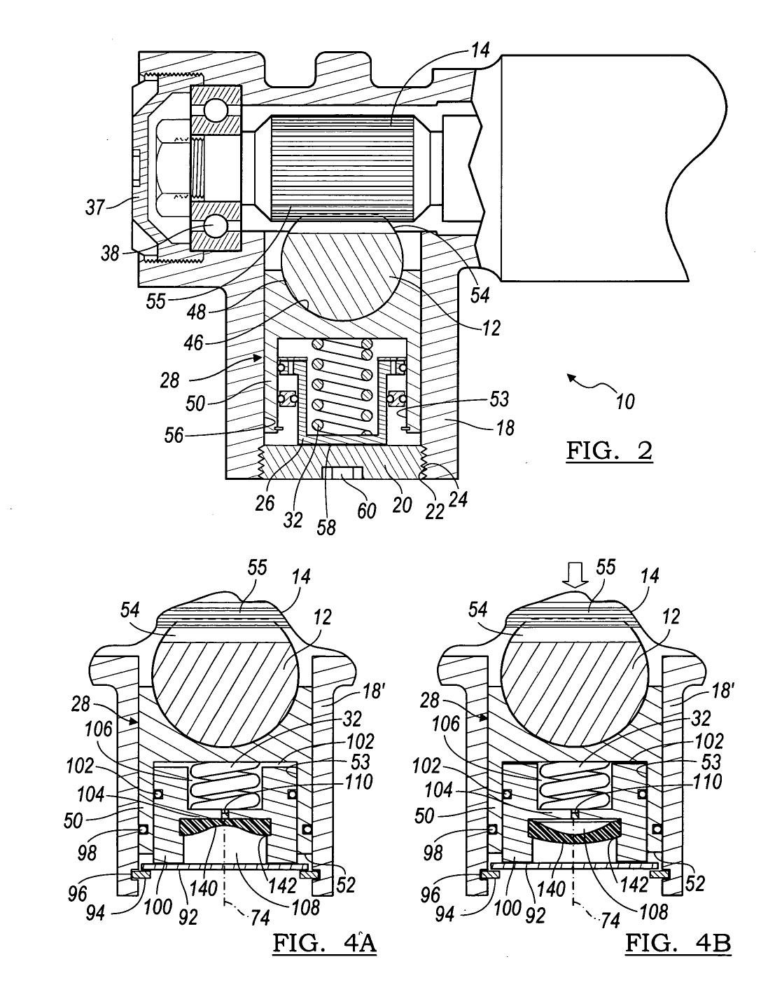

Referring first to FIGS. 1 and 2, a rack and pinion steering assembly includes a rack 12, whose axially opposite ends are connected to with vehicle wheels able to be steered by manual operation of a steering wheel by a vehicle operator. A pinion 14 having gear teeth in meshing engagement with gear teeth formed on the rack 12. A housing 16 enclosing the rack 12 and pinion 14 includes a cast main housing section 18. A circular yoke plug 20 having external threads 22, which engage internal threads 24 on the main section 18 of the housing, closes the upper end of a cylindrical yoke chamber.

A yoke 28 is disposed in a yoke chamber formed in the main housing section 18. A helical coiled compression spring 32, disposed between the yoke 28 and a piston cup 26, presses the yoke firmly against the rack 12 due to an elastic, resilient force produced by the spring.

A fluid motor 36 is connected with the rack 12 to assist in turning the vehicle wheels. The pinion 14 is supported for rotation on a bearing 38, fitted in the housing 16, and a nut 37, threaded into the housing, locates the bearing correctly and secures it in the housing. Rotating the steering wheel of the vehicle actuates a steering control valve assembly (not shown) to direct flow of hydraulic fluid to and from the fluid motor 36 through conduits 40 and 42. Although the fluid motor 36 is provided to assist in turning the vehicle wheels, it is contemplated that the rack and pinion steering assembly 10 could be manually actuated or could use an electric motor to assist in turning the vehicle wheels.

The yoke 28 has an arcuate inner surface 46, which forms a portion of a cylinder and engages arcuate outer surfaces 48 on the rack 12. The yoke spring 32 continually biases the arcuate inner side surface 46 on the yoke 28 toward the outer surface 48 of the rack 12. The yoke 28 is formed with a cylindrical side wall 50, which engages a cylindrical inner surface 56 of the main housing section 18. The yoke wall 50 is formed with a centrally located circular cylindrical bore 53.

The yoke plug 20 includes a flat circular inner surface 58, which faces the annular end surface on the yoke 28. A hexagonal socket 60 formed on the outer surface of the plug 20 can be engaged by a wrench, or a similar turning device, to install and remove the plug from the main housing section 18.

The rack and pinion steering assembly 10 is actuated to turn the steerable vehicle wheels when the operator turns the steering wheel. Because the gear teeth on the rack and pinion are helical teeth, the turning force transmitted between the engaged teeth has a component tending to force the rack teeth 54 away from engagement with the pinion teeth 55. This force urges the rack 12 and yoke 28 to move away from pinion 14 against the effect of the spring force. In addition, impulse forces transmitted from the road surface to the assembly 10 due to the wheels hitting potholes, rocks or debris, etc., called “road events,” can also move the rack away from pinion teeth 14 in a direction transverse to a longitudinal central axis of the rack.

Damping indicates the presence of some form of friction in the system. In the simplest form of damping, the friction force is proportional to the relative velocity between a moving body and another body. This type of damping, called velocity or viscous damping, results from the motion of a body through a fluid or from the viscosity of a film of lubricant between two bodies having relative motion.

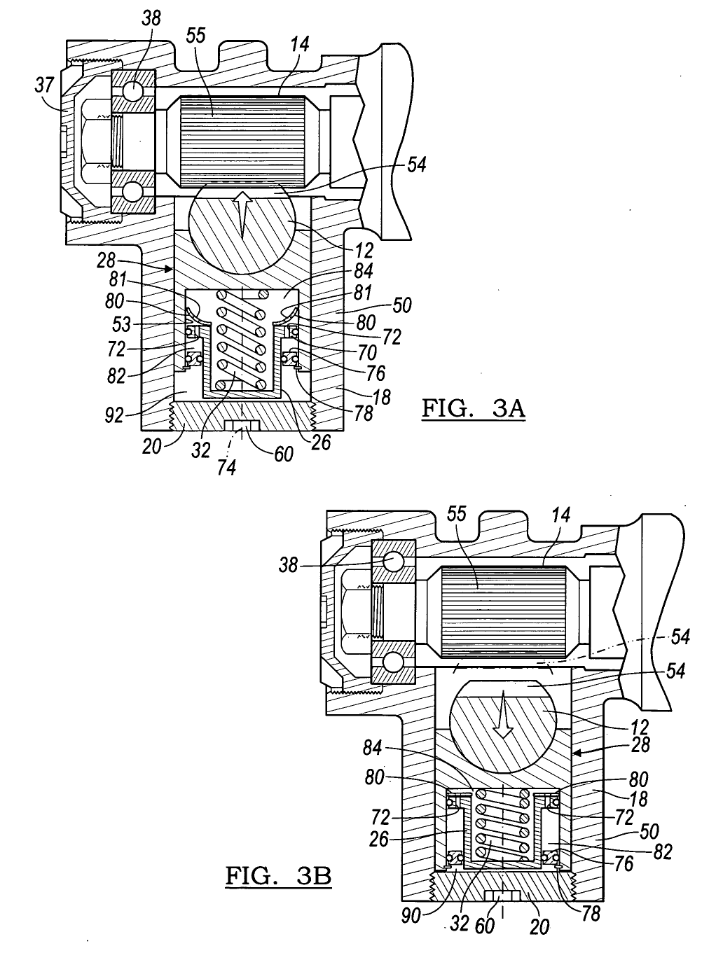

FIGS. 3A and 3B show in greater detail a damped yoke bearing for maintaining the rack 12 engaged with the pinion 14. The piston cup 26 is formed with an annular flange 70, which is sealed by an O-ring contacting the bore 53. The flange is formed with orifices 72 spaced angularly about the axis 74. A sealing ring 76, fitted between bore 53 and the outer radial surface of the piston cup 26, is sealed by O-rings at the bore 53 and cup 26. A snap ring or circlip 78, secured to the bore 53, limits axial movement of the piston cup 26 within the bore 53 and establishes the minimum width of an axial gap between the plug 20 and piston cup 26. Located on flange 70 at each orifice 72 is a valve 80, such as a reed valve, which pivots between a seated position on the flange and the unseated position, shown in FIG. 3. Control valve 80 is formed with an orifice 81 through its thickness. Preferably each orifice 72 has a larger cross sectional area than that of each orifice 81.

The sealed space 82 between flange 70 and seal ring 76 is filled with viscous hydraulic fluid. When the yoke 28 moves toward pinion 14 as spring 32 extends, fluid in pressure cavity 82 is pressurized, control valves 80 open, and fluid flows from cavity 82 through orifices 72 and orifices 81, if present, into the space 84 located above flange 70.

As FIG. 3B illustrates, when a road event occurs causing the teeth 54 of rack pinion 12 to try to disengage the teeth 55 of pinion 14, yoke 28 moves toward plug 20, spring 32 compresses, fluid in space 84 is pressurized, control valves 80 close, and fluid is throttled through the orifices 72 and 81, if present in the control valves, and flows into the pressure cavity 82. This forces seal ring 76 downward toward engagement with the circlip 78, thereby compressing air in the space 90 between plug 20 and the seal ring 76 and producing an upward neumatic force on the bottom of the seal ring 76. Preferably, the volumetric flow rate through orifices 81 is less than the flow rate through orifices 72. The damped yoke bearing resists movement of the yoke and rack, and tends to keep the teeth 54 of rack pinion 12 engaged with the teeth 55 of pinion 14 due to the upward spring force on the yoke, the upward pneumatic force on the seal ring, and the hydraulic dampening through orifices 80.

FIGS. 4A and 4B show a second embodiment of the invention in which the yoke 28 and rack 12 move along the axis 74 of the main housing section 18′. FIG. 4A illustrates the dampened yoke bearing in its normal operating position, i.e., with the rack 12 fully engaged with the pinion 14. A cover 92 is releaseably secured to the housing section 18′ by fitting a snap ring 94 in an annular recess 96 formed in the inner surface of the housing section 18′. The axial position of the cover 92 in the housing may be adjustable by replacing the cover 92 with the plug 20, which is threaded into the housing, as shown in FIG. 2.

The yoke 28 carries an O-ring seal 98, which is elastically pressed against the inner surface of the housing 18′. A piston 100 carries a seal 102, which is elastically pressed against the inner surface of the wall 50 of the yoke 28. The piston 100 includes a web 104, which divides the cylindrical space within the bore 53 into an upper cylinder portion 106, within which the spring 32 is located, and a lower cylinder portion 108. In the normal operating position of FIG. 4A, the lower surface 52 of the yoke 28 is spaced axially from the cover 92.

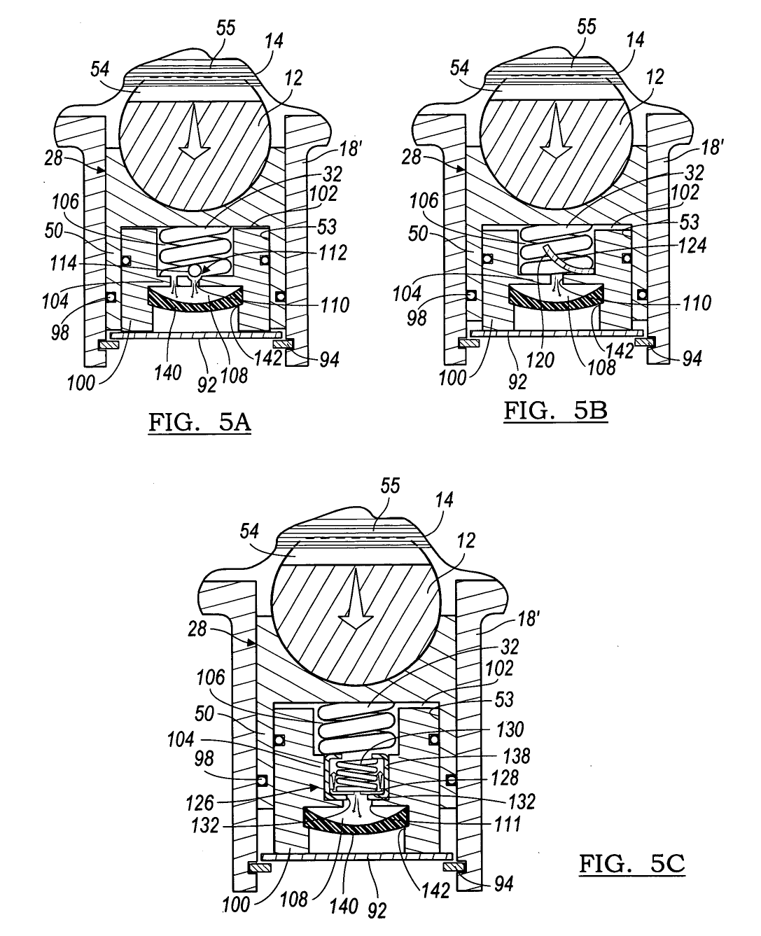

The compression spring 32, which maintains resilient contact with piston 100 and yoke 28, forces the piston 100 against the inner surface of the cover 92, thereby producing a clearance between the piston head and the adjacent surface of the yoke. The volume of that clearance and the rest of the residual volume of the upper cylinder portion 106 not occupied by the spring 32 is filled with viscous hydraulic fluid. The piston web 104 includes an orifice 110, through which the upper cylinder portion 106 communicates with the lower cylinder portion 108. Flow through orifice 110 can be controlled by a one-way check valve, such as the ball check valve 112 shown in FIG. 5A. Valve 112, which is actuated by differential pressure across the valve 112, opens orifice 110 by forcing ball 114 off its seat when pressure in the lower cylinder portion 108 exceeds pressure in the upper cylinder portion 106 and closes orifice 110 by forcing ball 114 into contact with its seat when pressure in the upper cylinder portion 106 exceeds pressure in the lower cylinder portion 108. The ball 114 is retained in position close to the seat by a porous cap (not shown).

Alternate pressure-actuated, one-way check valves suitable to control flow through orifice 110 are shown in FIGS. 5B and 5C. FIG. 5B illustrates a reed valve, whose control element 120 pivots on the piston web 104. Element 120 opens orifice 110 when pressure in the lower cylinder portion 108 exceeds pressure in the upper cylinder portion 106. Element 120 closes orifice 110 when pressure in the upper cylinder portion 106 exceeds pressure in the lower cylinder portion 108. Element 120 may be formed with an orifice through its thickness, as shown in element 80 of FIGS. 3A and 3B. The area of that orifice is sized to control the flow rate past valve 120 when orifice 110 is closed by the control element 122.

FIG. 5C illustrates a spring-biased, pressure-actuated check valve 126, located in a stepped orifice 111 formed in the piston web 104. The control element 128 is continually forced by a spring 130 into contact with a seat 132 having an aperture 134 located adjacent orifice 111. The spring is retained in a cage 138, which reacts the force of spring 130. Control element 128 opens orifice 111 and aperture 134 against the force of spring 130 when pressure in the lower cylinder portion 108 exceeds pressure in the upper cylinder portion 106. Element 128 closes orifice 111 and aperture 134 with the force of spring 130 when pressure in the upper cylinder portion 106 exceeds pressure in the lower cylinder portion 108.

Turning now to FIGS. 4A, 4B, 5A, 5B, 5C, a rubber disc 140, located at the lower end of the orifice 110, 111 in the piston web 104, is retained in an annular recess 142 formed in the piston wall. FIG. 4B shows the damped yoke bearing when force due to a road event moves the rack 12 and yoke 28 toward cover 92. When this occurs, the fluid in the upper cylinder portion 106 flows through the respective check valve 112, 120, 126, the orifice 110, 111 in the piston web 104, and into the lower cylinder portion 108, where it deflects the rubber disc 140 and fills a space between the disc 140 and the piston web 104.

The elasticity of the disc 104 continually urges the hydraulic fluid to return to the upper cylinder portion 106 through the orifice 110 and provides an elastic resistance to flow of the fluid into the lower cylinder portion 108.

Preferably the hydraulic fluid used to produce damping in the embodiments described with reference to FIGS. 2, 3A, 3B, 4A, 4B, 5A, 5B and 5C has a viscosity similar to that of grease, liquid tar or heavy oil such that its inherent viscosity further opposes its flow through orifices 72 and 110. However, other materials including viscoelastic elastomeric compounds, such as silicone (available commercially from Dow Corning and General Electric Company), Nitrile, and Viton (from DuPont) and liquid injection molded compounds (LIM), can be used effectively to provide damping in a yoke bearing according to this invention.

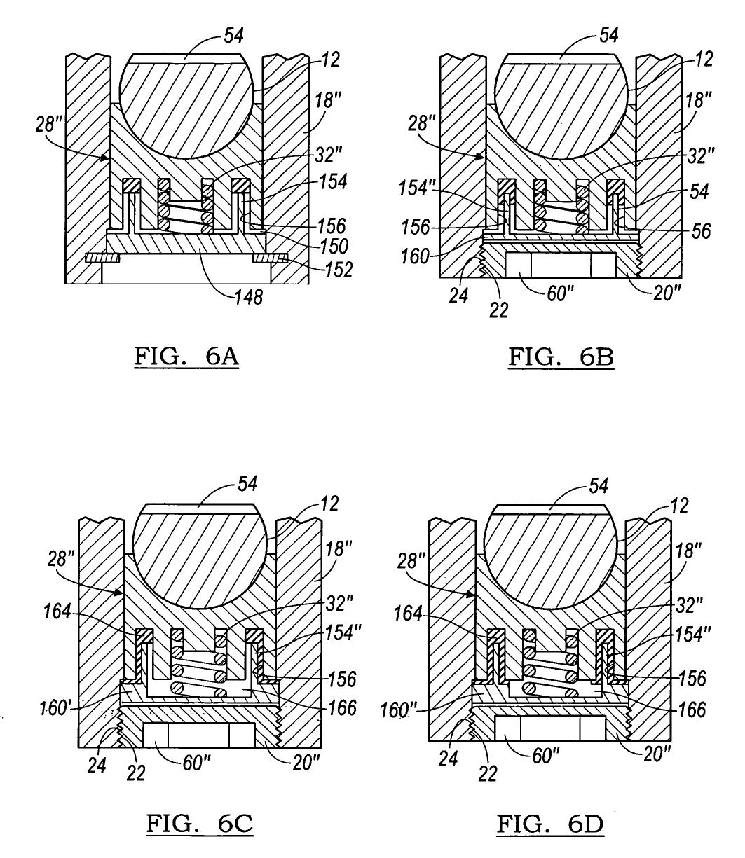

Materials that are viscous, paste-like liquids in their static, ambient condition, and turn progressively from liquid to a higher viscosity liquid and to a solid with the application of increasing pressure or force are preferred. For example, such material are soft with a durometer of about 50 at low pressure and become hard with a durometer of about 90, harder than the rubber of a tire for an automotive vehicle, at elevated pressure. The embodiments described with reference to FIG. 6A-6D are particularly suited to make best use of the force vs. deflection relation attainable with the viscoelastic properties of LIM.

Turning now to FIG. 6A, the main housing section 18″ is closed by a plug 148, whose axial location is limited by an internal shoulder 150 and by a circlip 152, secured to internal surface of the housing section. The plug 148 is formed with a cylindrical projection 154 located in an annular recess 156 formed in the lower surface of the yoke 28″. A compression spring 32″ contacting the yoke 28″ and plug 148 continually elastically biases the yoke and rack 12 upward toward engagement with the pinion 14. The recess 156 contains viscoelastic damper material located above the cylindrical projection 154. When a road event forces the yoke 28″ and rack 12 toward the plug 148, the cylindrical projection 154 enters the viscoelastic damper material causing the viscoelastic damper material to flow along the walls of the recess 156 and surfaces of the projection 154. This movement of the viscoelastic damper material produces a viscoelastic resistance to displacement of the yoke and rack, which acts in the same direction as the force of spring 32″ to return the teeth 54 of the rack 12 to engagement with the teeth 55 of the pinion 14. The area of the surfaces along which the viscoelastic damper material makes contact influences the degree of damped resistance to displacement of the rack and yoke.

FIG. 6B shows an embodiment in which the main housing section 18″ is closed by a threaded plug 20″, whose axial location is adjustable in accordance with the extent of engagement of its threads 22 into the threads 24 of the main housing section 18″. A plate 160, located immediately above plug 20″, is formed with the cylindrical projection 154″ located in an annular recess 156 formed in the lower surface of the yoke 28″. Compression spring 32″ contacting the yoke 28″ and plug 20″ continually, elastically biases the yoke and rack 12 upward toward engagement with the pinion 14. The recess contains viscoelastic damper material located above the cylindrical projection 154. When a road event forces the yoke 28″ and rack 12 toward the plug 20″, the cylindrical projection 154 enters the viscoelastic damper material causing it to flow along the walls of recess 156 and surfaces of the projection 154. This movement of the viscoelastic damper material produces a viscoelastic resistance to displacement of the yoke and rack, which acts in the same direction as the force of spring 32″ to return the teeth 54 of the rack 12 to engagement with the teeth 55 of the pinion 14. The area of the surfaces along which the viscoelastic damper material makes contact influences the degree of damped resistance to displacement of the rack and yoke.

FIG. 6C shows an embodiment in which the main housing section 18″ is closed by the threaded plug 20″, whose axial location is adjustable in accordance with the extent of engagement of its threads 22 into the threads 24 of the main housing section 18″. A plate 160′, located immediately above plug 20″, is formed with the cylindrical projection 154″ located in the annular recess 156 formed in the lower surface of the yoke 28″. Compression spring 32″, which contacts the yoke 28″ and plug 20″, continually, elastically biases the yoke and rack 12 upward toward engagement with the pinion 14. Viscoelastic damper material 164 is located in the recess 156 above the cylindrical projection 154 and along the radial outer surface of the projection 154″. The radial inner side of projection 154″ in the recess 156 is vacant; the space 166 between the lower surface of the yoke 28″ and the plate 160′ is vacant. When a road event forces the yoke 28″ and rack 12 toward plug 20″, the cylindrical projection 154″ enters the viscoelastic damper material causing it to flow along the walls of recess 156 and surfaces of the projection 154. This movement of the viscoelastic damper material produces a viscoelastic resistance to displacement of the yoke and rack, which acts in the same direction as the force of spring 32″ to return the teeth 54 of the rack 12 to engagement with the teeth 55 of the pinion 14.

FIG. 6D shows an embodiment in which the main housing section 18″ is closed by the threaded plug 20″, whose axial location is adjustable in accordance with the extent of engagement of its threads 22 into the threads 24 of the main housing section 18″. A plate 160″, located immediately above plug 20″, is formed with the cylindrical projection 154″ located in the annular recess 156 formed in the lower surface of the yoke 28″. Compression spring 32″, which contacts the yoke 28″ and plug 20″, continually, elastically biases the yoke 28″ and rack 12 upward toward engagement with the pinion 14. Viscoelastic damper material 164 is located in the recess 156 above the cylindrical projection 154 and along both the radial outer and inner surfaces of the projection 154″. The space 166 between the lower surface of the yoke 28″ and the plate 160′ is vacant and able to receive viscoelastic damper material displaced from the recess 156. When a road event forces the yoke 28″ and rack 12 toward plug 20″, the cylindrical projection 154″ enters the viscoelastic damper material causing it to flow along the walls of recess 156 and the surfaces of projection 154″. This movement of the viscoelastic damper material produces a viscoelastic resistance to displacement of the yoke and rack, which acts in the same direction as the force of spring 32″ to return the teeth 54 of the rack 12 to engagement with the teeth 55 of the pinion 14. As the yoke 28″ and rack 12 return to the normal operating position, the viscoelastic damper material located in space 166 returns to the recess 156.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A damped yoke bearing for a power steering system of a vehicle comprising:
a first component including gear teeth for engaging gear teeth on a second component;
a yoke;
a spring for biasing the yoke into contact with the first component; and
a damper for producing damped resistance to displacement of the yoke away from the first component.

2. The yoke bearing of claim 1 wherein the damper produces a relative high magnitude of damped resistance to displacement of the yoke away from the first component and a lower magnitude of damped resistance to displacement of the yoke toward the first component.

3. The yoke bearing of claim 1, wherein the damped resistance is at least one of viscous damping and viscoelastic damping.

4. The yoke bearing of claim 1 further comprising:
a cylinder including a first portion whose volume varies in response to movement of the yoke, and a second portion;
an orifice hydraulically connecting the first portion and the second portion;
a valve for alternately opening and closing communication between the first portion and the second portion through the orifice in responsive to movement of the yoke.

5. The yoke bearing of claim 4 wherein the valve includes a reed element supported for pivoting and located to seat at the orifice, the reed element being responsive to pressure across the orifice for opening the orifice when the reed is unseated and for closing the orifice when the reed is seated.

6. The yoke bearing of claim 4 wherein the valve includes a ball, a seat located at the orifice, and a cage containing the ball, the ball being responsive to pressure across the orifice for opening the orifice when the ball is unseated and closing the orifice when the ball is seated.

7. The yoke bearing of claim 4 wherein the valve includes a plate, a seat for the plate located at the orifice, a second spring biasing the plate to seat, the plate being responsive to pressure across the orifice for opening the orifice when the plate is unseated and for closing the orifice when the plate is seated.

8. The yoke bearing of claim 1 further comprising:
a cylinder containing the spring;
a piston cup located in the cylinder, the piston cup including a flange that divides the cylinder into a first portion whose volume varies in response to movement of the yoke, and a second portion, the flange being formed with an orifice hydraulically connecting the first portion and the second portion; and
a valve supported on the flange, for alternately opening and closing communication between the first portion and the second portion through the orifice in responsive to movement of the yoke.

9. The yoke bearing of claim 1 further comprising:
a cylinder containing the spring;
a piston cup located in the cylinder, the piston cup including a flange that divides the cylinder into a first portion whose volume varies in response to movement of the yoke, and a second portion, the flange being formed with an orifice hydraulically connecting the first portion and the second portion;
a seal ring located in the second portion of the cylinder, sealed against passage of fluid, and displaceable in the cylinder due to differential pressure across the seal ring; and
a valve supported on the flange, for alternately opening and closing communication between the first portion and the second portion through the orifice in responsive to movement of the yoke.

10. The yoke bearing of claim 9 further comprising:
a main housing section containing the yoke and the piston cup; and
a plug secured to the main housing section at a variable axial position, spaced axially from the piston cup, and hydraulically sealing the main housing section.

11. The yoke bearing of claim 1 further comprising:
a cylinder containing the spring;
a piston located in the cylinder including a web that divides the cylinder into a first portion whose volume varies in response to movement of the yoke, and a second portion, the web being formed with an orifice hydraulically connecting the first portion and the second portion; and
an elastic disc supported on the piston and located in the second portion adjacent the orifice, the valve alternately opening and closing communication between the first portion and the second portion through the orifice in response to movement of the yoke.

12. The yoke bearing of claim 11 further comprising:
a main housing section containing the yoke and the piston; and
a plug secured to the main housing section at a fixed axial position, spaced axially from the yoke, and hydraulically sealing the main housing section.

13. A damped yoke bearing for a power steering system of a vehicle comprising:
a housing;
a first component including gear teeth for engaging gear teeth on a second component;
a yoke located in the housing and containing viscoelastic material;
a spring located in the housing for biasing the yoke into contact with the first component; and
a surface secured to the housing, located for displacement into contact with the viscoelastic material in response to movement of the yoke relative to the surface.

14. The damped yoke bearing of claim 13 wherein:
the yoke is formed with a recess containing the viscoelastic material;
the surface is located in the recess, the surface and recess providing a space wherein the viscoelastic material can move when the viscoelastic material is displaced by contact with the surface as the yoke moves relative to the surface.

15. The damped yoke bearing of claim 13 further comprising:
a plate secured to the housing, formed with the surface and located on a projection extending into the recess, the projection providing a space between the recess and the projection, in which space the viscoelastic material can move on the surface when the yoke moves relative to the surface

16. The damped yoke bearing of claim 13 wherein:
the yoke is formed with an annular recess containing the viscoelastic material;
the damper yoke bearing further comprising:
a plate secured to the housing and formed with the surface located on an annular projection extending into the recess, the projection providing a space between the recess and the projection, in which space the viscoelastic material can move on the surface when the yoke moves relative to the surface; and
a plug secured to the housing at a variable axial position and spaced axially from the plate.

17. The damped yoke bearing of claim 13 wherein the viscoelastic material is a liquid injection molded material.

18. A damped yoke bearing for a power steering system of a vehicle comprising:
a housing;
a rack including gear teeth for engaging gear teeth on a pinion;
a yoke located in the housing and formed with an annular recess containing the viscoelastic material;
a spring located in the housing for biasing the yoke into contact with the first component; and
a plate secured to the housing and formed with the surface located on an annular projection extending into the recess, the projection providing a space between the recess and the projection, in which space the viscoelastic material can move on the surface when the yoke moves relative to the surface.

19. The damped yoke bearing of claim 18 wherein the viscoelastic material is a liquid injection molded elastomer.

20. The damped yoke bearing of claim 18 further comprising;
a plug secured to the housing at a variable axial position and spaced axially from the plate.
